(19) United States
(12) Patent Application Publication
(10) Pub. No.: US 2018/0105443 A1
(43) Pub. Date: Apr. 19, 2018

(54) WATER TREATMENT SYSTEM AND WATER TREATMENT METHOD

(71) Applicant: Mitsubishi Electric Corporation, Chiyoda-ku, Tokyo (JP)

(72) Inventors: Noboru WADA, Chiyoda-ku (JP); Kyohei AKETAGAWA, Chiyoda-ku (JP); Eiji IMAMURA, Chiyoda-ku (JP); Yusuke NAKAGAWA, Chiyoda-ku (JP); Hiroshi KUROKI, Chiyoda-ku (JP); Yasutaka INANAGA, Chiyoda-ku (JP)

(73) Assignee: Mitsubishi Electric Corporation, Chiyoda-ku, Tokyo (JP)

(21) Appl. No.: 15/567,209

(22) PCT Filed: May 27, 2015
(86) PCT No.: PCT/JP2015/065190

§ 371 Date: Oct. 17, 2017

(51) Int. Cl. C02F 1/78; C02F 11/06; C02F 3/12

(52) U.S. Cl. CPC C02F 1/78; C02F 11/06; C02F 2201/782; C02F 2209/235; C02F 3/12

(57) ABSTRACT

A water treatment system includes: an aeration tank for converting wastewater containing organic substances into sludge-laden treated water by aerobic treatment; an ozone supply unit for feeding ozone into the sludge-laden treated water drawn out from the aeration tank; and a bubble detector for detecting the condition of bubbles produced by reaction between the fed ozone and the sludge. The ozone treatment is controlled by utilizing as an indicator for sludge volume reduction effect the increase rate of bubbles detected by the bubble detector, so that the water treatment system is able to vary the amount of ozone feed depending on the conditions of water treatment.

### TECHNICAL FIELD

The present invention relates to water treatment systems for reducing the volume of an impurity in water by utilizing ozone.

### BACKGROUND ART

A volume reduction method its known that reduces the volume of an impurity in water using ozone. For example, an activated sludge treatment method utilizing microorganisms is supposed here for treating effluent water, i.e., wastewater. In the supposed treatment, microorganisms consume organic substances in the wastewater. At that time, a large volume of excess sludge will be produced in the wastewater as organic substances are consumed by microorganisms. The excess sludge produced is an example of the impurity in the water, and has been subjected to treatment mainly such as incineration and drying and then disposed of in landfills. Since the treatment and disposal of the excess sludge produced require a great deal of energy and costs, and new sites for landfill, there have been developed volume reduction technologies for volume reduction of excess sludge by utilizing ozone (see, for example, Patent Documents 1 to 3).

### PRIOR ART DOCUMENT

### Patent Document

Patent Document 1: JP2001-191097 A;

Patent Document 2: JPH09-150185 A; and

Patent Document 3: JP2008-207122 A.

### SUMMARY OF THE INVENTION

### Problem that the Invention is to Solve

Treating wastewater flowing into an aeration tank using an activated sludge treatment method will produce excess sludge in the aeration tank. In the above-mentioned volume reduction technologies, at least a part of treated wastewater containing excess sludge thus produced is brought into contact with ozone, whereby the volume reduction of the excess sludge is performed. The amount of ozone supply used for volume reduction of the excess sludge is generally determined in advance on the basis of a result of experiments conducted for given conditions of wastewater. That is, the volume reduction of excess sludge is performed by supplying the predetermined amount of ozone.

However, the flow rate and the quality of wastewater flowing into the aeration tank generally vary from hour to hour. For that reason, an optimal amount of ozone supply for volume reduction of excess sludge needs to be also varied from hour to hour. Thus, if a predetermined amount of ozone is fixedly supplied for the volume reduction of excess sludge, there may raise an oversupply or an undersupply condition of ozone with respect to the amount of excess sludge to be volume-reduced. Oversupply of ozone will lead to all uneconomic operation and undersupply thereof will lead to an insufficient excess-sludge volume reduction effect.

Monitoring quality change of wastewater and adjusting the amount of ozone supply on the basis of the monitoring result may be considered as a countermeasure for avoiding such an oversupply or an undersupply condition of ozone. Monitoring the quality of wastewater by measurement, however, needs expensive analysis equipment for measuring mixed liquor suspended solids (MLSS), total organic carbon (TOC), chemical oxygen demand (COD), and the like. This will significantly increase in the wastewater treatment cost.

The present invention is made to resolve such problems and aimed at providing a water treatment system and a water treatment method that can avoid in oversupply and an undersupply conditions of ozone as quickly as possible by varying the amount of ozone supply depending on conditions of the treatment.

### Means for Solving the Problem

A water treatment system according to the present invention is for reducing volume of an impurity in treated water by feeding ozone thereinto. The water treatment system includes an ozone supply unit configured to feed a predetermined amount of the ozone into the treated water; a bubble detector configured to detect bubbles produced by reaction between the ozone and the impurity; a determination part configured to determine whether an increasing rale of the detected bubbles is relatively low or relatively high; and a control unit configured to control the ozone supply unit to feed the ozone when the determination part determines that the increasing rate of the bubbles is relatively low and not to feed the ozone when the determination part determines that the increasing rate of the bubbles is relatively high.

Another water treatment system according to the present invention is for reducing volume of an impurity in treated water by feeding ozone thereinto. The water treatment system includes an ozone supply unit configured to feed a predetermined amount of the ozone into the treated water; a bubble detector configured to detect bubbles produced by reaction between the ozone and the impurity; and a control unit configured to control the ozone supply unit to vary a feed amount of the ozone depending on whether a detected increasing rate of the bubble is relatively low or relatively high.

A water treatment method according to the present invention is for reducing volume of an impurity in treated water using a water treatment system that feeding ozone thereinto. The water treatment method include: a supply step of feeding a predetermined amount of the ozone into the treated water in the water treatment system; a detection step of detecting bubbles produced by reaction between the ozone and the impurity; and a determination step of determining whether an increasing rate of the detected bubbles is relatively low or relatively high, wherein the ozone is fed in the feed step when the increasing rate of the bubbles is determined to be relatively low in the determination step, and the ozone is not fed in the feed step when the increasing rate of the bubbles is determined to be relatively high in the determination step.

### Advantage of the Invention

According to a water treatment system of the present invention, bubbles produced by reaction of an impurity such as sludge with ozone are detected and the detected increase rate of the bubbles is utilized as an indicator for sludge volume reduction effect, thereby varying the amount of ozone supply depending on conditions of the water treatment. Consequently, an oversupply and an undersupply condition of ozone can be avoided as quickly as possible without using expensive analysis equipment.

### BRIEF DESCRIPTION OF THE DRAWINGS

FIG. 1 a schematic diagram showing a configuration of a water treatment system according to the embodiment 1 of the present invention;

FIG. 2 is a schematic axial cross sectional view showing an electrode configuration of an electric discharge type ozone generator used in the water treatment system according to the embodiment 1;

FIG. 3 is a schematic lateral cross-sectional view showing an electrode configuration of the electric discharge type ozone generator used in the water treatment system according to the embodiment 1;

FIG. 4 is a graph for explaining a relation between a running cost of and an ozone concentration in the ozonized oxygen gas generated by the electric discharge type ozone generator used in the water treatment system according to the embodiment 1;

FIG. 5 is a diagram for explaining relations between the generated amounts of bubbles and the supply amount of ozone used in the water treatment system according to the embodiment 1;

FIG. 6 is a schematic diagram showing a configuration of a water treatment system according to the embodiment 2 of the present invention;

FIG. 7 is a schematic diagram showing a configuration of a water treatment system according to the embodiment 3 of the present invention;

FIG. 8 is a schematic diagram showing a configuration of a water treatment system according to the embodiment 4 of the present invention;

FIG. 9 is a graph for explaining relations between sludge volume reduction effects and ozone concentrations used in the water treatment system according to the embodiment 4;

FIG. 10 is a schematic diagram showing a configuration of a water treatment system according to the embodiment 5 of the present invention;

FIG. 11 is a schematic diagram showing a configuration of a water treatment system according to the embodiment 6 of the present invention;

FIG. 12 is a schematic diagram showing a configuration of a water treatment system according to the embodiment 7 of the present invention;

FIG. 13 is a schematic diagram showing a configuration of a water treatment system according to the embodiment 8 of the present invention; and

FIG. 14 is a schematic diagram showing a configuration of a water treatment system according to the embodiment 9 of the present invention.

### EMBODIMENTS FOR CARRYING OUT THE INVENTION

Hereinafter, embodiments of the water treatment systems and the water treatment methods disclosed in the present application are described in detail with reference to the accompanying drawings. It should be noted that the following embodiments are only examples and the present invention is not limited to these examples.

### Embodiment 1

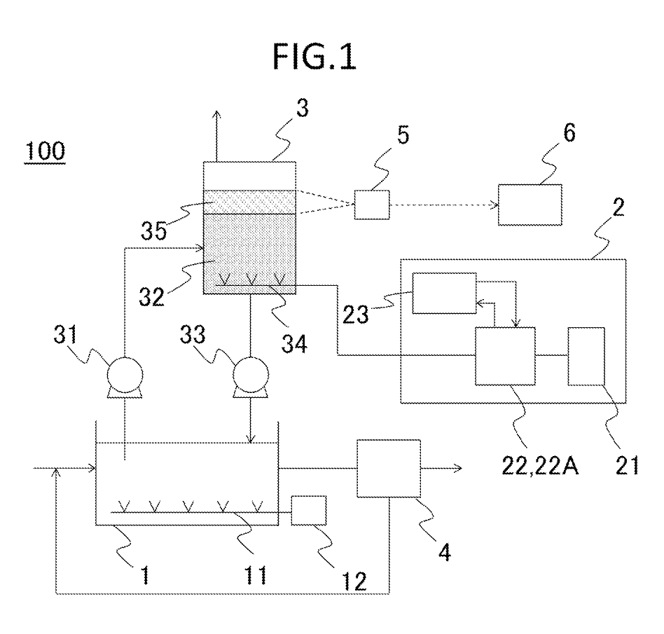

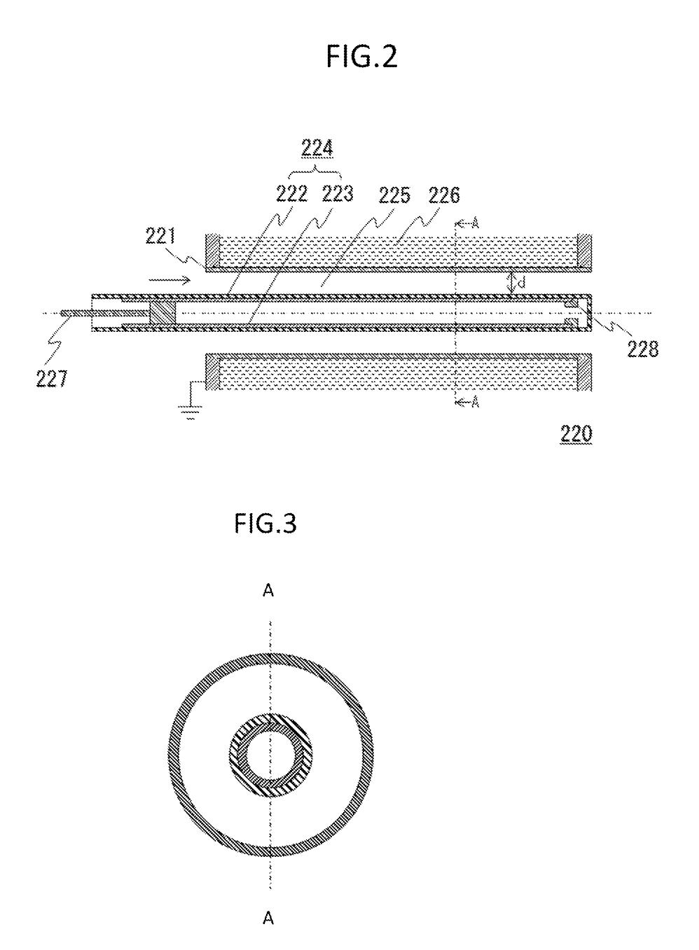

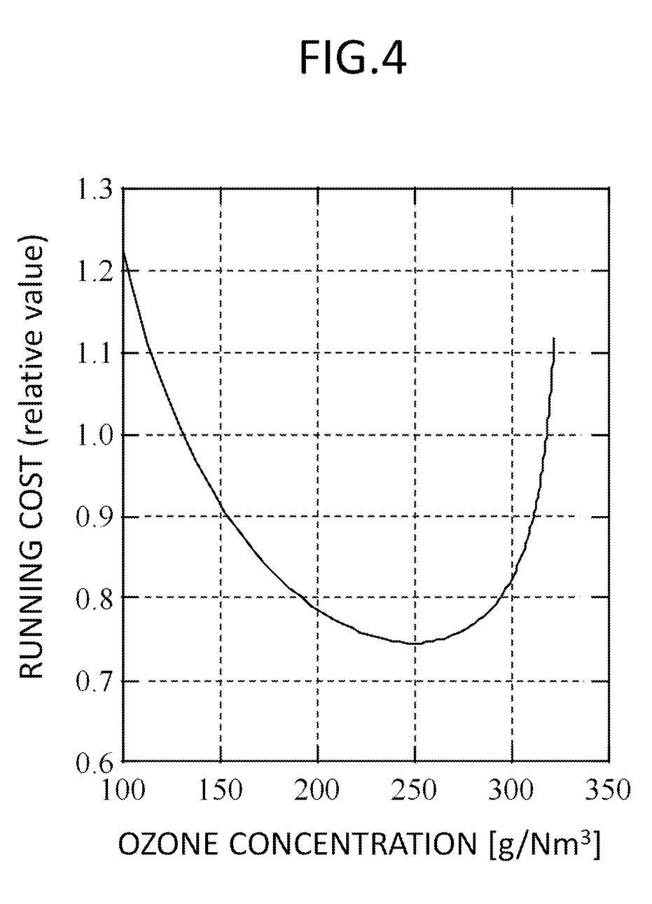

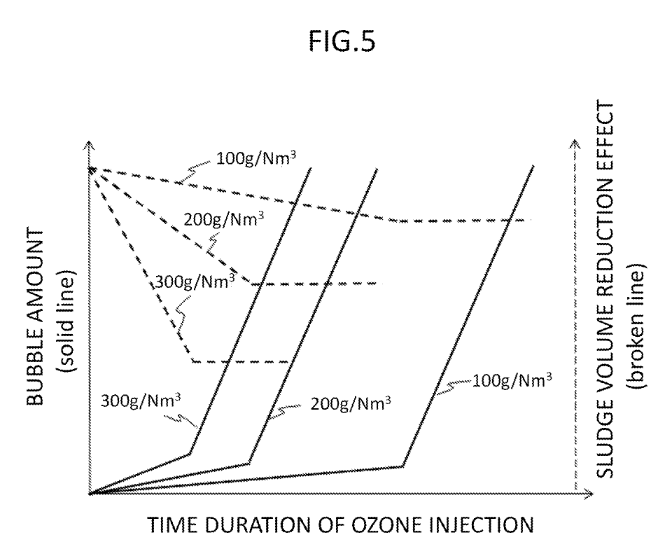

FIGS. 1 to 5 are for explaining a water treatment system according to the embodiment 1 of the present invention. FIG. 1 is a schematic diagram showing a component configuration, a control configuration, an operation flow, and the like of the water treatment system; FIG. 2 is a schematic longitudinal cross sectional view showing an electrode configuration of an electric discharge type ozone generator used in the water treatment system according to the embodiment 1; FIG. 3 is a schematic lateral cross sectional view showing the electrode configuration, taken along the line A-A in FIG. 2; FIG. 4 is a graph for explaining a relation between a running cost of and an ozone concentration in the ozonized oxygen gas generated by the electric discharge type ozone generator used in the water treatment system according to the embodiment 1; and FIG. 5 is a diagram for explaining a relation between the production amount of bubbles and the volume reduction effect with respect to duration of ozone injection.

A water treatment system 100 according to the embodiment 1 includes an aeration tank 1. Organic substance-containing wastewater, which is an example of water to be treated, is treated in the aeration tank 1 under an aerobic condition using microorganisms, to generate sludge-laden treated water that is water containing sludge, an example of an impurity. The water treatment system 100 further includes an ozone treatment section 3 for ozonating the sludge-laden treated water drawn from the aeration tank 1 with the ozonized oxygen gas fed from an ozone supply unit 2 (by executing a feed step); a post treatment section 4 having a settling tank, a membrane separation tank, or the like; a bubble detector 5 for detecting (executing a detection step) the condition of bubbles produced by reaction of the sludge with the fed ozone; and a control unit 6 receiving a signal from the bubble detector 5, for controlling the ozone supply unit on the basis of the received signal. The ozone treatment section 3 is an example of a reception part of the present invention, because it receives the treated water to be ozonated from the aeration tank 1 containing microorganisms.

Part of the treated water in the aeration tank 1 flows out into the post treatment section 4 from the aeration tank 1. In the post treatment section 4, excess sludge is separated from the flowing-out treated water. Not only wastewater, which is raw wastewater to be treated, sent from wastewater sources flows into, but also the excess sludge separated in the post treatment section 4 is recycled into the aeration tank 1 via a pump. An air diffuser 11 is provided in the aeration tank 1 to introduce air from an air supply source 12 into the aeration tank 1. While the air supply source 12 is different in type depending on a necessary amount of air supply, any of a blower, a compressor, and a pump may be used.

The ozone supply unit 2 is made up of a raw material gas supply part 21, an ozone generation part 22, and a cooler part 23. The raw material gas supply part 21 is provided with a blower, a compressor, or the like when using air as a raw material gas. In the raw material gas supply part 21, dry air, in which moisture is removed as necessary, is introduced into an ozone generator 22A. A heat- or pressure-regenerative type dehumidifier is used for the moisture removal. When oxygen is used as the raw material gas, a liquid oxygen tank, or an oxygen generator utilizing vacuum pressure swing adsorption (VPSW) or the like is used. In addition, an additive gas supplier may be used if necessary that adds nitrogen, air, or carbon dioxide of 0.05% to 5% with respect to the amount of supplied oxygen.

The ozone generation part 22 is provided with the electric discharge type ozone generator 22A and operates on the basis of a necessary ozone concentration, a necessary ozone supply amount, and a required running cost, and further of the command of the control unit 6.

The cooler part 23 is provided with a circulation pump for circulating a coolant for cooling the ozone generator 22A, a cooler for cooling the coolant increased in temperature by absorbing heat generated in the ozone generator 22A. A heat exchange type cooler selected among a liquid-liquid type one or a liquid-gas type one, a liquid-chlorofluorocarbon type chiller, or the like can be used as the cooler. A cryogenic cooler may be used, in a case of cooling at very low temperature. Ordinary tap water is used as an example for the coolant. Other coolant such as a water mixed with an antifreeze liquid, a scale remover or the like, an ion-exchange water, or pure water may be used. Further, ethylene glycol, ethanol, or the like may be used.

Next, a configuration of the ozone generator 22A according to the embodiment 1 is described. The ozone generator 22A is a silent discharge type ozone generator that has electric discharge electrodes disputed opposite each other to form an electric discharge space, in which electric discharge is established via a dielectric. FIGS. 2 and 3 show an electric discharge electrode part 220 of the ozone generator 22A as an example of an ozone generator having cylindrical tube type electrodes. Various types such as of a parallel plate type may be applied to the electrodes. The electric discharge electrode part 220 is provided with a high voltage electrode tube 224. The high voltage electrode tube 224 is made up of a cylindrical high voltage electrode (conductive layer) 223 and a dielectric glass tube 222 integrated with the high voltage electrode 223 so as to cover the outer circumferential surface of and one end of the high voltage electrode 223. While the raw material gas flows through the electric discharge space, which is described later, the one end of the high voltage electrode tube 224 is closed for the gas not to enter into the high voltage electrode tube 224. Since the ozone, by-products and the likes produced by the electric discharge exist more in the downstream side of the gas flow, the downstream end of the high voltage electrode tube 224 is closed so that the ozone and the other products do not enter thereinto. The high voltage electrode tube 224 has an outer diameter of 30 mm or smaller. The high voltage electrode 223 is a metal thin film formed such as of aluminum, chromium, titanium, nickel, an alloy containing any of these metals, or stainless steel. An earth electrode tube 221 is formed such that the coolant 226 flows on the outer side thereof and disposed concentrically with the high voltage electrode tube 224, with the inner surface of the earth electrode tube facing the outer surface of the high voltage electrode tube 224 with a predetermined gap distance d. Thus, the electric discharge space 225 is formed between the outer circumference surface of the dielectric 222 and the inner circumference surface of the earth electrode tube 221. The electric discharge space 225 serves as a gas passageway for the raw material gas to flow in the direction shown by the arrow in the figure and also serves as a space for electric discharge caused by an AC high voltage applied between the earth electrode tube 221 and the high voltage electrode tube 224. A power feed member 227 for applying the high voltage to the high voltage electrode 223 is inserted in the high voltage electrode tube 224 from the upstream open end thereof, and a field grading layer 228 for suppressing surface electric discharge is provided to the downstream end closed with the dielectric 222. The power feed member 227 is connected with the high voltage electrode 223 in the upstream outside of the earth electrode tube 221 so that an arc does not continue when an interelectrode shorting occurs. Note that the power feed member 227 is not shown, in the cross-section of FIG. 3.

In the ozone generator 22A, the discharge electrode part 220 or a plurality of such discharge electrode parts 220 arranged parallel in proportion to a necessary amount of ozone generation is accommodated in one tank. The ozone generator 22A is further provided with an AC high voltage power unit and the likes to apply a given AC voltage to each discharge electrode part 220. The oxygen-containing raw material gas is fed to each electric discharge space 225 of discharge electrode parts 220 from a raw material gas supply part 21 and the AC high voltage is applied via the power feed member 227, so that ozone is generated by electric discharge in the raw material gas.

An example of the operation condition and the configuration common to the ozone generator 22A according to the embodiment 1 is described. An example of a preferable configuration and a preferable operation condition of the ozone generator 22A are described specifically for a case of using an oxygen-containing gas as the raw material gas. The gap distance d of the electric discharge space 225 formed in the electric discharge electrode part 220 of the ozone generator 22A according to the embodiments 1 to 5 is set to a value between no narrower than 0.1 mm and no wider than 0.6 mm, preferably between no narrower than 0.2 mm and no wider than 0.6 mm. Setting the gap distance d to 0.6 mm or narrower improves the efficiency of cooling the electric discharge space 225, thereby enhancing the efficiency of ozone generation, compared with that of an ozone generator having a gap distance of over 0.6 mm. A narrower gap distance, on the other hand, causes high electric field intensity in the discharge space 225, thereby increasing by-products such as nitrogen oxides. If the gap distance d is set narrower than 0.3 mm in a case of using air as the raw material gas, too high electric field intensity is formed in the electric discharge space 225, so that formation of nitrogen oxides increases significantly and will lead to reduction of the efficiency of ozone generation. This is undesirable. In a case of requiring a higher concentration ozone gas, an oxygen-rich gas is used as the raw material gas. In such a case, a narrower gap distance d can be employed because formation of nitrogen oxides reduces compared with the case of using air as the raw material gas. In addition, a gap distance d of 0.1 mm is near a limit of forming a uniform gap from a viewpoint of manufacturing technology. Accordingly, the gap distance is preferably 0.2 mm or wider. Moreover, setting the gap distance d to a value of over 0.6 mm raises excessively the temperature in the discharge space 225. This may probably decrease the efficiency of ozone generation.

The efficiency of ozone generation varies depending on not only the gap distance d but also the gas pressure P in the discharge space 225. An operation condition of the ozone generator 22A in the embodiment 1 is such that the gas pressure P is set to 0.2 MPaG (G: gauge pressure) or lower, preferably no lower than 0.05 MPaG but lower than 0.2 MPaG, more preferably no lower than 0.1 MPaG but lower than 0.2 MPaG. Particularly, in a case of using air as the raw material gas, increasing the gas pressure P suppresses nitrogen oxide formation in the discharge space 225. The gas pressure P is set to a maximum discharge pressure of the raw material gas supply part 21, which is about 0.2 MPaG for a case of using a blower for example. An upper and a lower discharge pressure limit of the raw material gas supply part 21 depend on the ozonized gas pressure necessary for the ozone treatment section 3 (for example, at least 0.05 MPaG or higher for water treatment plants). In addition, setting the gas pressure P than 0.2 MPaG exempts the ozone generator 22A from the provision of the Class 2 pressure vessel. This mitigates the legal restrictions and facilitates its handling and the like. Thus, in the embodiments 1 to 5, the gap distance d is set between no wider than 0.1 mm and no narrower than 0.6 mm, between no wider than 0.3 mm and no narrower than 0.6 mm for the case of using air as the raw material gas, and between no wider than 0.1 mm and no narrower than 0.3 mm for the cases of using an oxygen-rich row material gas and requiring a high concentration ozone gas as with the case of using a liquid oxygen tank or an oxygen generator. Furthermore, the configuration of the ozone generator is selected so that a maximum ozone generation efficiency and a minimum NOx production can be achieved by adjusting the gas pressure P depending on the kinds of the raw material gas and the required ozone concentration.

A power density to be input to the ozone generator 22A (input power per area of the electrode) is preferably between 0.05 W/cm² and 0.6 W/cm², between no less than 0.1 W/cm² and no more than 0.4 W/cm ² for the case of using air as the raw material gas, and between no less than 0.3 W/cm² and no more than 0.6 W/cm² for the case of using an oxygen-rich raw material gas as with the case of using an oxygen generator. The input power density is a measure representing the size of the ozone generator 22A. A high input power density allows downsizing of the ozone generator. A high input power density, on the other hand, leads to increase of the temperature in the discharge space 225 and to decrease of the efficiency of ozone generation. Since the temperature in the discharge space 225 is preferably low from the viewpoint of ozone generation by electric discharge and suppression of nitrogen oxide production, the input power density needs to be not excessively high. However, an input power density of lower than 0.05 W/cm² is undesirable because it may possibly cause the electric discharge condition to fluctuate and make it impossible to maintain stable electric discharge.

The ozone generator 22A is capable of supplying an ozone gas with its concentration ranging from 100 to 400 g/Nm³. In addition, a higher concentration ozone gas has been generally used for improving process throughput in chemical industry.

FIG. 4 shows a relation between an ozone concentration supplied by and a running cost of the ozone generator 22A according to the embodiment 1. In FIG. 4, the vertical axis represents the running cost of the ozone generator 22A and the horizontal axis represents the ozone concentration supplied by the ozone generator 22A. The running cost on the vertical axis expresses a relative value in a case of defining as one a cost minimum of a conventional ozone generator, i.e., a cost for generating an ozone concentration of 150 g/Nm³. The running cost of the ozone generator 22A according to the embodiment 1 decreases with the ozone concentration in its range from 100 g/Nm³ to about 250 g/Nm³ and increases with the ozone concentration in its range over 200 g/Nm³, as shown in FIG. 4, Namely, this shows that a trend of a cost minimum appears in the ozone concentration of around 200 g/Nm³. In other words, using a too low- or a too high-concentration ozone gas is unfavorable from the viewpoint of running cost. In particular, variation of the running cost in the higher concentration range is significant large. Although improvement in throughput of chemical process itself is expected in a case of too high concentration, it is obvious that the too high concentration is impractical because it involves a larger running cost burden. Thus, the ozone generator 22A according to the present embodiment exhibits a cost merit of at least 10% or more with respect to a running cost of a conventional ozone generator, and the ozone generator 22A is operated so as to generate an ozone gas with a concentration ranging from 150 to 310 g/Nm³ that brings no excess increase in the running cost, preferably from 190 to 290 g/Nm³ that brings a cost merit of 20% or more.

The ozone treatment section 3 is constructed to be able to retain the sludge-laden treated water 32 drawn out from the aeration tank 1 via a pump 31 and to return the treated water after ozonated to the aeration tank 1 via a pump 33. An ozone gas diffuser 34 is placed at the bottom of the ozone treatment section 3 to introduce into the ozone treatment section 3 the ozone gas supplied from the ozone supply unit 2.

Reaction between the treated water and the ozone gas occurs in the ozone treatment section 3. Unreacted ozone gas is evacuated from the ozone treatment section 3 through a pipe 36 (not shown) and is discharged to the atmosphere after subjected to waste ozone treatment. Note that while a detail mechanism of reaction between treated water and ozone gas remains unknown, it is known that bubbles 35 are produced (see, for example, Patent Document 2).

At least one bubble detector 5 is disposed on an outside face or the upper face of the ozone treatment section 3 to detect the presence of the bubbles 35 produced in the ozone treatment section 3. From the viewpoint of visibility, a necessary portion of the ozone treatment section 3 is made up of a transparent material to externally detect the condition of the bubbles produced thereinside. The bubble detector 5 is configured to be able to measure an increasing rate of production of the bubble 35 by using a sensor such as an image sensor, a displacement sensor, or a level sensor. For example, the increase rate of the bubbles 35 can be obtained by measuring the height of or the amount of bubbles 35 raised/produced per unit time in the ozone treatment section 3. The control unit 6 receives the measurement result transmitted thereto and determines whether or not the measurement result satisfies a predetermined condition and issues an operational command based on the determination result to the ozone supply unit 2. In other words, the control unit 6 functions also as a determination part of the present invention. Specifically, the determination is made (the determination step is executed) whether the increase rate of bubbles is relatively low or relatively high, which described later. Regarding a way of executing the determination, for example, preliminary tests are conducted to obtain a reference increase rate of the bubbles and the obtained reference increase rate is stored beforehand. Then, the determination can be made by comparing a currently measured increase rate to the beforehand stored increase rate. In addition, the bubble detector 5, if it has no problems with ozone resistance and water resistance, may be disposed inside the ozone treatment section 3. The determination part executes repetitive processing of repeating the determination. When the determination part determines that the increase rate of bubbles is relatively high, the control unit stops the repetitive processing and then resumes the repetitive processing after a predetermined time elapses. Thus, execution of the unnecessary determination is skipped, so that the load to the control unit 6 can be reduced.

The post treatment section 4 configured with a settling tank, a membrane separation tank, and the like. The post treatment section 4 separates the sludge-laden treated water flowing out from the aeration tank 1 into excess sludge and treated effluent to be discharged. The excess sludge separated is recycled to the aeration tank 1 via a pump 41 (not shown). In the membrane separation, a membrane module used in a so-called membrane separation activated sludge method may be employed.

The volume reduction of excess sludge in the water treatment system thus configured is implemented in the following processes. The untreated raw wastewater flowing into the aeration tank 1 and the recycled sludge returned from the post treatment section 4 are subjected to biological treatment in the aeration tank 1 and become the sludge-laden treated water. The sludge-laden treated water is drawn out from the aeration tank 1 to the ozone treatment section 3 via the pump at a constant interval, to be retained therein. The sludge in the drawn-out sludge-laden treated water reacts in the ozone treatment section 3 with the ozone gas fed from the ozone supply unit 2 and is reformed into easily degradable substances to be enhanced in its biodegradability. The reformed sludge is recycled to the aeration tank 1 and assimilated as a source of biochemical oxygen demand (BOD) by aerobic microorganisms, thus resulting in volume reduction of the sludge.

However, raw wastewater flowing into the aeration tank 1 varies in its nature from hour to hour. Accordingly, it is difficult to estimate in advance an optimal ozone feed necessary for implementing sludge volume reduction. A configuration in which conditions of the influent raw wastewater are constantly analyzed with expensive analysis equipment or the like and the analysis result is transmitted in real time to the ozone supply unit 2 to control the amount of ozone fed from the ozone supply unit 2, is practically difficult even in light of costs and the like. Ozone feed excessive or deficient for the amount of sludge to be treated causes undesirable results in that an expected sludge volume reduction effect cannot be achieved or waste consumption of ozone gas is generated. Under current state of the art, there has been no indicator that shows whether or not the amount of ozone currently fed is a proper value, and the fact is that the amount of ozone feed is determined on the basis of a case study result or an ambiguous indicator based on operator experience.

The inventors took note of conditions of the bubbles produced by reaction of sludge-laden treated water with the ozone gas. FIG. 5 shows relations between time duration of ozone feed to the sludge and the amounts of bubbles produced by the reaction with the ozone gas fed to the sludge. The horizontal axis represents the time duration of ozone feed by injection. The vertical axes represent the amount of bubbles (solid lines) produced by injecting the ozone into the ozone treatment section 3 and sludge volume reduction effect (broken lines). The production amount of the bubbles increased with the time duration of ozone injection, as shown in FIG. 5. in a case of feeding an ozone concentration of 100 g/Nm³, the production amount of bubbles significantly increased after a certain time duration of ozone injection. The sludge volume reduction effect, on the other hand, showed a trend of decreasing with the time duration of ozone injection, as shown in FIG. 5. In the case of feeding the ozone concentration of 100 g/Nm³, the sludge volume reduction effect decreased for certain time duration of ozone injection, but the decrease was not observed and a minimum and constant sludge volume reduction effect was observed after the certain time duration. Put differently, the sludge volume reduction effect falling below the minimum value was not observed even though the ozone was further fed after the certain time duration, i.e., after the bubble increase rate changed from relative low to relative high. Also in cases of feeding ozone concentrations of 200 g/Nm³ and 300 g/Nm³, the amounts of bubbles increased significantly and minimum and constant sludge volume reduction effects were observed after certain time durations of ozone injection. Put differently, also in the cases of feeding the ozone concentrations of 200 g/Nm³ and 300 g/Nm³, the sludge volume reduction effects falling below the minimum values were not observed even though the ozone was further fed after the certain time durations, i.e., after the bubble increase rates changed from relatively low to relatively high.

As described above, the inventors found that the amounts of bubble production changed in two phases with respect to the time duration of ozone feed in any cases of feeding the ozone concentrations of 100, 200, and 300 g/Nm³. The inventors further found that the increase rate of bubbles in the first phase of ozone feed depended on the feed-ozone concentration whereas the increase rate of bubbles in the second phase of, i.e., in the later phase of ozone feed was independent of the feed-ozone concentration and was substantially constant. In FIG. 5, the broken line in a lower part of the graph exhibits a higher capability of sludge volume reduction effect. This shows that there is a correlation between the increasing rate of bubbles and the sludge volume reduction effect. As shown in FIG. 5, it was confirmed that the sludge volume reduction effect increased with increasing time duration of ozone feed in the early phase of ozone feed, but it was not confirmed that the sludge volume reduction effect further increased with increasing time duration of ozone feed in the later phase of ozone feed. Also, biodegradability of the sludge considerably increased in the early phase of ozone feed but the increase rate of biodegradability became low in the later phase thereof. For that reason, the point at the sharp change in the increase rate of bubbles is considered to be a minimum amount of ozone feed that brings about a maximum sludge volume reduction effect. That is, it is considered that the amount of ozone feed corresponding to the time duration of ozone feed at the point where the increase rate of the bubbles sharply changes, shows a proper amount—neither excessive nor deficient—of ozone feed. While there has been no analysis equipment (no instrument) capable of analyzing biodegradability of sludge in real time, the present embodiment shows that sufficient increase in the biodegradability can be monitored in real time by detecting the increase rate of bubbles.

In the present embodiment, the ozone supply unit 2 is operated so that the ozone gas is fed in the early phase of ozone feed, in other words, in the period during which the increase rate of bubbles is determined to be relatively low, and then feed of the ozone gas is stopped at the timing when the increase rate of bubbles is determined to be relatively high owing to sharp rise of the increase rate of bubbles. By controlling in this way the ozone supply unit 2, an optimum feed-ozone concentration, and an optimum time duration of ozone feed, i.e., an optimum amount of ozone feed can be set by utilizing the condition of bubbles as an indicator. Moreover, since feed of ozone gas is reduced (preferably, no ozone is fed) during the phase of no further enhancement of sludge volume reduction effect (the phase of the high increase rate of bubbles) after the reaction between the ozone and the sludge occurs preferentially, suppression of excessive ozone gas feed and volume reduction of excess sludge can be concurrently achieved as quickly as possible. If the ozone gas feed is continued after the timing of sharp rise in the increase rate of bubbles, i.e., in the later phase of ozone feed, the fed ozone does not effectively work for sludge volume reduction because the ozone is preferentially consumed by soluble organic substances dissolving from the inside of cell walls disrupted in the period of the low increase rate of bubbles. Thus, in the present embodiment, an optimum ozone gas feed can be achieved by utilizing the condition of bubbles as an indicator for sludge volume reduction.

The increase rate of bubbles cannot be specifically determined even in any of the early phase and the later phase of ozone feed because it varies such as by nature of the activated sludge and the quality of raw wastewater flowing into the aeration tank. The increase rate of bubbles shows a linear relationship with the time duration of ozone feed or the amount of ozone feed, and the increase rate of bubbles in the later phase of ozone feed becomes more than twice that in the early phase thereof. Accordingly, the timing of sharp rise in the increase rate of bubbles is very clear. For that reason, the control of ozone feed can be easily achieved using the condition of bubbles as the indicator.

The ozone gas is preferably fed periodically and intermittently to the sludge-laden treated water drawn out from the aeration tank 1. The periodic and intermittent reaction of ozone with sludge and recycle of the sludge ozonated thereby to the aeration tank 1 allow for suppressing increase of organic substance degradation load of microorganisms in the aeration tank 1, so that the quality of the treated water can be prevented from deterioration due to decrease of activity of microorganisms in the aeration tank 1. The period of the ozone gas feed may be appropriately set depending on the organic substance degradation load of microorganisms in the aeration tank 1, the production amount of excess sludge, and the like. The feed period in the present embodiment ranges from no shorter than 1 hour to no longer than 24 hours, preferably from no shorter than 2 hours to no longer than 12 hours, move preferably from no shorter than 4 hour to no longer than 6 hours. For example, in a case of 6-hour period of ozone feed, the ozone gas is fed four times per day. If the period of ozone gas feed is shorter than the above range, the frequency of returning the ozonated sludge to the aeration tank 1 is high, so that the organic substance degradation load of microorganisms in the aeration tank 1 cannot be mitigated and the activity of microorganisms in the aeration tank 1 decreases. This results in quality deterioration of the treated water. If the period of ozone gas feed is longer than the above range, on the other hand, the growth rate of microorganisms due to the organic substances contained in the wastewater may exceeds the excess-sludge reduction rate brought about by the ozone gas feed. In this case, the production amount of excess sludge cannot possibly be reduced.

A recycle sludge ratio, which is defined as a value calculated by dividing a per-day ozonated sludge amount by a per-day excess sludge production amount, may be appropriately set depending on the organic substance degradation load of microorganisms, the excess sludge production amount, or the like in the aeration tank 1. In the present embodiment, the treated sludge ratio is set to no lower than 0.5 but no higher than 5; preferably no lower than 2 but no higher than 3. If the recycle sludge ratio becomes lower than 0.5, the excess-sludge volume reduction effect brought about by the ozone feed reduces. In this case, volume reduction of the excess sludge cannot be achieved. If the recycle sludge ratio exceeds 5, on the other hand, the treated water deteriorates in quality because microorganisms in the aeration tank 1 reduce and activity thereof lowers. In particular, the recycle sludge ratio ranging between no lower than 2 and no higher than 3 allows for effectively achieving volume reduction of the excess sludge while keeping activity of microorganisms in the aeration tank. For that reason, the recycle sludge ratio is preferably set to range from no lower than 2 to no higher than 3.

In the present embodiment, in order to obtain the bubble amount that indicates an optimal ozone feed amount, a calibration period should be set at any timing in an interval such as once a week after or immediately before the sludge volume reduction treatment is started. In order to input to the control unit a typical value indicating a wastewater condition at the calibration, a simple test on sludge volume reduction is conducted in the calibration period to obtain a correlation between the bubble amount and the ozone feed amount by measuring the two phase characteristic in the increase rate of bubbles and the amount of or the time duration of ozone feed at which the sharp change in bubbles occurs, as shown in FIG. 5. After the result of the calibration is input to the control unit, the sludge volume reduction treatment is actually operated. It should be noted that, past calibration data is not deleted but accumulated. This contributes to improvement in precision of the learning control for the ozone supply unit 2.

After the actual operation is started, the control unit 6 compares the continuously monitored the bubble amount with the calibration data and determines an optimal amount of the ozone feed for the current condition of the wastewater using the function of learning data including the past one, to send on an as-needed basis the updated result on a necessary ozone amount to the ozone supply unit 2. The ozone supply unit 2 controls, on the basis of the updated result, any quantity or multiple quantities of the current, the voltage, the power, the frequency, the control pulse width, and the control pulse density applied, to the ozone generator 22A, and. the flow rate of raw material gas supplied thereto and the gas pressure and the cooling temperature thereof, to adjust the ozone concentration and the amount of ozone generation to be supplied.

With the above control, the time duration of automated ozone gas feed is automatically determined so that the ozone gas is fed during the low increase rate of bubbles and the feed of ozone gas is reduced and stopped during the high increase rate of bubbles. A specification for the intermittent feed of the ozone gas is determined along with the ozone gas feed period described above. At the time point when the increase rate of the bubbles rises sharply, power supply to the ozone generator 22A is stopped and the operation of the ozone supply unit 2 is thereby stopped. At the same time, operations of related devices, pumps, and not shown valves are also controlled.

As described above, according to the water treatment system of the present embodiment, the amount of ozone feed is controlled by utilizing the amount of or the increase rate of bubble production accompanied by the reaction between the sludge retained in and the ozone fed into the ozone treatment section 3. That is, since the condition of bubbles is utilized as the indicator for volume reduction of the sludge, the sludge volume reduction effect can be stably maintained with a proper amount of ozone feed without detecting the amount of and the quality of influent wastewater and without using an expensive analysis equipment, thus contributing to downsizing and cost reduction of the ozone generator.

### Embodiment 2

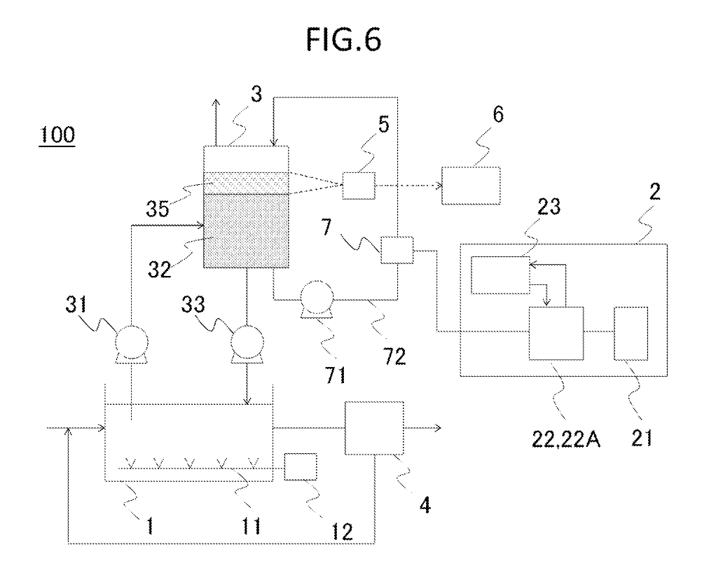

A water treatment system according to the embodiment 2of the present invention is described. The water treatment system according to the embodiment 2 is basically the same in configuration and operation as the embodiment 1, but is different in that the ozone gas is fed to the ozone treatment section not through the ozone gas diffuser but through an ejector. FIG. 6 is a schematic diagram showing a component configuration, a control configuration, an operation flow, and the like of the water treatment system according to the embodiment 2. In the figure, components as same as or corresponding to those of the water treatment system according to the embodiment 1 are designated at the same reference numerals, and their descriptions are omitted unless otherwise necessary.

In the embodiment 1, the ozone gas fed from the ozone supply unit 2 is injected into the sludge-laden treated water from the ozone gas diffuser placed in the ozone treatment section 3. In the embodiment 2, a circulation pipe 72 is provided to the ozone treatment section 3 as shown in FIG. 6. The circulation pipe 72 is for circulating the sludge-laden treated water drawn out from the aeration tank 1 and retained in the ozone treatment section 3 via an ejector 7 and a pump 71. The ejector 7 uses the sludge-laden treated water as a driving fluid and aspirates the ozone gas supplied from the ozone generation unit 2 to feed the ozone gas into the sludge-laden treated water. The reaction of the sludge with the ozone is substantially completed in the ejector 7 and the circulation pipe 72, and the bubbles 35 produced therein are retained in the ozone treatment section 3. In the present embodiment, the ejector 7 is used to shatter the sludge therein, thereby enhancing the efficiency of reaction between the sludge and the ozone gas and enhancing the sludge volume reduction effect.

As described above, the water treatment system according to the present embodiment controls the amount of ozone supply utilizing the amount of or the increase rate of the bubble production accompanied by the reaction between the ozone and the sludge retained in the ozone treatment section 3. In other words, the amount of ozone supply is controlled by utilizing the condition of bubbles as the indicator for the sludge volume reduction. As a result, the amount of ozone feed can be optimized as quickly as possible while keeping stably the sludge volume reduction effect independently of the amount of and the quality of influent wastewater and without using expensive analysis equipment. Thus, the ozone supply unit 2 does not need to feed excess ozone, contributing to downsizing and cost reduction of the ozone generator. Moreover, use of the ejector 7 further enhances the efficiency of reaction of ozone with the sludge, thus contributing to downsizing of the ozone treatment section 3 and to further enhancement of the sludge volume reduction effect.

### Embodiment 3

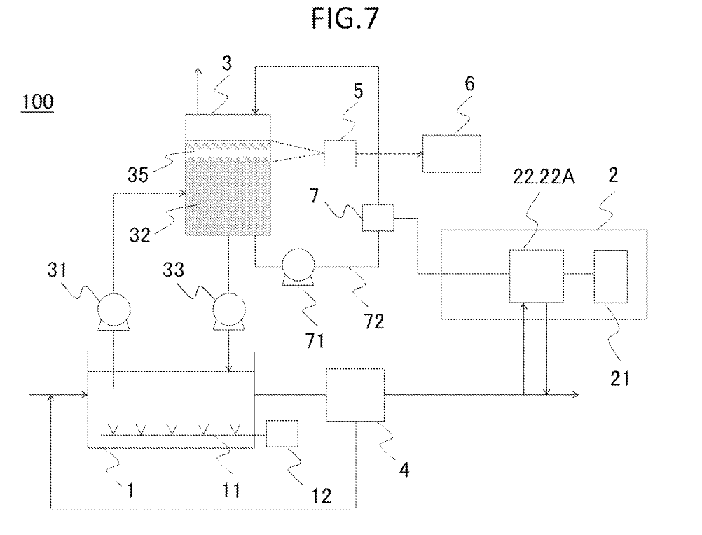

A water treatment system according to the embodiment 3 of the present invention is described. The water treatment system according to the embodiment 3 is basically the same in configuration and operation as the embodiment 1 or 2, but is different in that the ozone generation part in the ozone supply unit is cooled by the treated effluent from the post treatment section. FIG. 7 is a schematic diagram showing a component configuration, a control configuration, an operation flow, and the like of the water treatment system according to the embodiment 3. In the figure, components as same as or corresponding to those of the water treatment system according to the embodiment 1 or 2 are designated at the same reference numerals, and their descriptions are omitted unless otherwise necessary.

While the ozone generation part 22 in the embodiments 1 and 2 is configured to be cooled by the cooler 23, the ozone generator 22A of the embodiment 3, which corresponds to the ozone generation part 22, is cooled by using the treated effluent to be discharged from the post treatment section 4, as shown in FIG. 7. The post treatment section 4 and the ozone generator 22A are interconnected via a not shown circulation pump. In addition, while in FIG. 7, the ozone gas is fed into the ejector 7 and then the treated water ozonated is returned to the ozone treatment section 3, the ozone gas may be fed from the ozone gas diffuser as shown in the embodiment 1.

While the ozone generation part 22 is cooled by means of a heat exchanger, a chiller, tap water, or the like as described in the embodiments 1 and 2, any of the means generates additional costs such as the initial cost of such equipment, and the power cost and the water cost. Hence, in the embodiment 3, part of the treated effluent separated by the post treatment section 4 is used as the cooling water for the ozone generator 22A, to reduce the costs. In this case, a pump only needs to be provided for supplying the water from the post treatment section 4. This is quit economical. Water having such quality that its pH of is least not extremely high or low and further its residual chlorine concentration is not so high as to induce corrosion at welding points of the structure can be used for cooling the ozone generator 22A. Since the cooling water duct for the ozone generator 22A is relatively narrow, coarse waste in the treated effluent is preferably removed through a filter or the like.

As described above, the water treatment system according to the present embodiment controls the amount of ozone supply utilizing the amount of or the increase rate of the bubble production accompanied by the reaction between the ozone and the sludge retained in the ozone treatment section 3. In other words, the amount of ozone feed is controlled by utilizing the condition of bubbles as the indicator for the sludge volume reduction. As a result, the amount of ozone supply can be optimized as quickly as possible while continuously keeping stably the sludge volume reduction effect independently of the amount of and the quality of influent wastewater and without using expensive analysis equipment. Thus, the ozone supply unit 2 does not need to feed excess ozone, contributing to downsizing and cost reduction of the ozone generator. Moreover, it is economical that the treated effluent from the aeration tank 1 and separated in the post treatment section 4 is used for cooling the ozone generation part 22.

### Embodiment 4

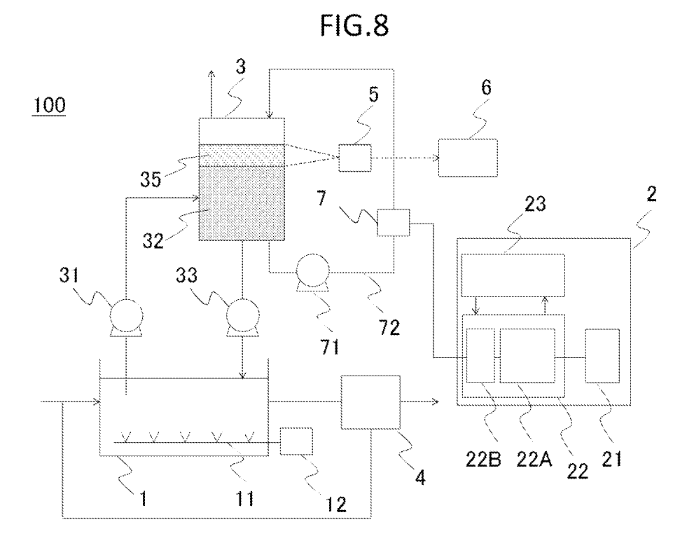

A water treatment system according to the embodiment 4 of the present invention is described. The water treatment system according to the embodiment 4 is basically the same in configuration and operation as the embodiments 1 to 3, but is different in that the ozone generation part in the ozone supply unit includes the ozone generator and an ozone concentrating and storing device. FIG. 8 is a schematic diagram showing a component configuration, a control configuration, an operation flow, and the like of the water treatment system according to the embodiment 4. In the figure, components as same as or corresponding to those of the water treatment system according to the embodiments 1 to 3 are designated at the same reference numerals, and their descriptions are omitted unless otherwise necessary.

In the embodiments 1 to 3, the ozone supply unit 2 is provided with the ozone generator 22A and the ozone gas generated by the ozone generator 22A is directly supplied from the ozone supply unit 2. The ozone generation part 22 shown in FIG. 8, however, is provided with the ozone generator 22A and an ozone concentrating and storing device 22B, and the ozone gas generated by the ozone generator 22A is concentrated by the ozone concentrating and storing device 22B to be supplied to the ozone generation part 22. The ozone generation part 22 feeds the concentrated ozone gas to the sludge via the ejector 7. In addition, while the ozone gas is fed into the ejector 7 and then the treated water ozonated is returned to the ozone treatment section 3 as shown in FIG. 8, it may be fed from the ozone gas diffuser as described in the embodiment 1.

The ozone concentrating and storing device 22B is for adsorptive concentration of the ozone gas from the ozone generator 22A and an example of an ozone concentrating device according to the present invention. From the viewpoint of running cost, the ozone generator 22A should be operated at an ozone concentration ranging from 150 g/Nm³ to 310 g/Nm³, preferably from 100 g/Nm³ 290 g/Nm³ as shown in FIG. 4. The ozone concentrating and storing device 22B is capable of concentrating the ozone gas from the ozone generator 22A up to a maximum of 2,000 g/Nm³. Use of the ozone concentrating and storing device 22B allows for using an ozone generator smaller in size than the ozone generator 22A that operates alone in the embodiment 1, thus making the ozone supply unit 2 have a very economical configuration.

The ozone concentrating and storing device 22B has absorbent held therein. The absorbent selectively absorbs/desorbs the ozone from the ozonated oxygen gas to obtain a super concentrated ozone gas. Silica gel or the like is used for the absorbent. In the ozone concentrating and storing device 22B, the temperature and pressure of an adsorption/desorption column filled with the absorbent is controlled to make an optimal condition for adsorption/desorption, whereby a desired ozone concentration can be obtained.

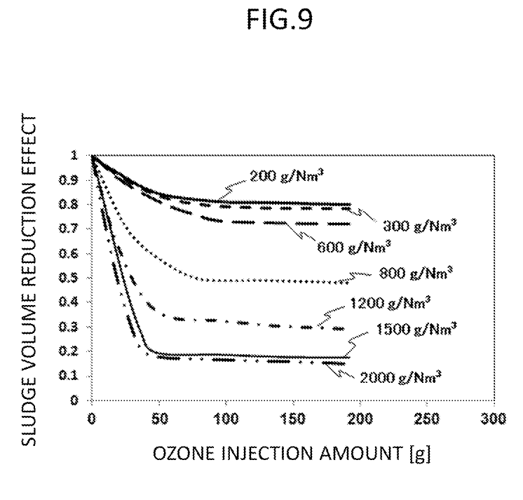

The water treatment system according to the present embodiment allows the ozone gas having an ozone concentration of over 310 g/Nm³ described in the embodiment 1 to react with the sludge-laden treated water at low cost. FIG. 9 shows variation of an ozone concentration effect on sludge volume reduction. It was confirmed from the figure that a significant sludge volume reduction effect of reducing the amount of sludge to half or less was brought about particularly in the ozone concentration ranging from 800 g/Nm³ to 1,500 g/Nm³. The drastically increase of the sludge volume reduction effect is considered due to the fact that biodegradability of the treated sludge is significantly enhanced and the cell walls of microorganisms in the sludge can be effectively disrupted, in the above-range of ozone concentration. In the ozone concentration of lower than 800 g/Nm³, while a certain level of the sludge volume reduction effect was brought about, the effect fell short of that brought about in the above range and larger amount of ozone was needed for the volume reduction. In the ozone concentration of over 1,500 g/Nm³, on the other hand, it was observed that the rate of improvement in the sludge volume reduction effect began to decrease with the ozone concentration. The supply ozone concentration is adjusted by controlling the pressure and temperature of the ozone concentrating and storing device 22B. A lower temperature and a lower pressure are needed for supplying an ozone-enriched gas with its concentration ever 1,500 g/Nm³. This raises problems in control aspect of the device and its cost. For that reason, the upper limit of ozone concentration is preferably 1,500 g/Nm³.

Note that in the water treatment system according to the present embodiment, high-purity oxygen without containing impurities such as nitrogen is preferably used as the raw material gas for the ozone generator 22A from the viewpoint of stably ensuring the above effect. Moreover, when the ozone gas is fed into the ejector 7, the gas at the beginning of aspiration may contain a lot of oxygen gas. Accordingly, the gas at the beginning of aspiration is preferably returned to the ozone generator 22A through an oxygen returning pipe 24 (not shown). Operating the ozone supply unit in this way allows the high-purity ozone gas to be stably fed to the ozone treatment section 3.

As described above, the water treatment system according to the present embodiment controls the ozone feed by utilizing the amount of or the increase rate of bubble production accompanied by the reaction between the ozone and the sludge retained in the ozone treatment section 3. Put differently, the amount of ozone feed is controlled by utilizing the condition of bubbles as the indicator for the sludge volume reduction. As a result, the amount of ozone feed can be optimized as quickly as possible while keeping stably the sludge volume reduction effect independently of the amount of and the quality of influent wastewater and without using expensive analysis equipment. Thus, the ozone supply unit 2 does not need to feed excess ozone, contributing to downsizing and cost redaction of the ozone generator. Moreover, the ozone concentrating and storing device 22B allows for supplying a super concentrated ozone gas of over 310 g/Nm³, thereby further enhancing biodegradability of the sludge to be treated. Consequently, the sludge volume reduction effect can be enhanced by effectively disrupting cell walls of microorganisms in the sludge, and an effect of being able to reduce the necessary amount of ozone supply can also be expected.

### Embodiment 5

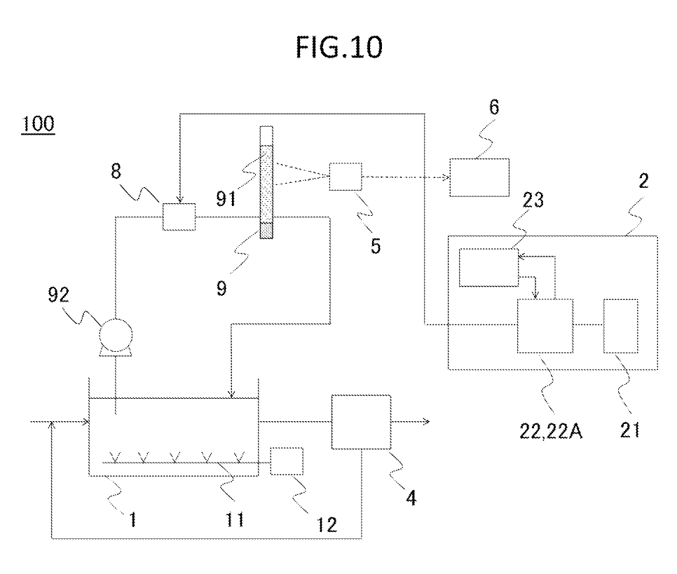

A water treatment system according to the embodiment 5 of the present invention is described. The water treatment system according to the embodiment 5 is basically the same in configuration and operation as the embodiments 1 to 4, but is different in that the ozone gas is allowed to continuously react with the sludge. FIG. 10 is a schematic diagram showing a component configuration, a control configuration, an operation flow, and the like of the water treatment system according to the embodiment 5. In the figure, components as same as or corresponding to those of the water treatment system according to the embodiments 1 to 4 are designated at the same reference numerals, and their descriptions are omitted unless: otherwise necessary.

The embodiments 1 to 4 employ a so-called batch type treatment method, in which the ozone gas is introduced to the ozone treatment section 3 via the ozone gas diffuser 34 or into the ejector 7 to react with the sludge. In an example of the embodiment 5 shown in FIG. 10, the ozone treatment section 3 is omitted, and the sludge-laden treated water in the aeration tank 1 continuously reacts in an ejector 8 with the ozone gas fed from the ozone supply unit 2. This contributes to downsizing of the system. In addition, in order to reduce the organic substance degradation load of microorganisms, the intermittent and periodical operation is also preferable to the above continuous reaction configuration.

A bubble indicator 9 is provided to a pipe connecting the ejector 8 to the aeration tank 1. The bubble indicator 9 is made up of, for example, a thin transparent tube for visually observing the condition of the fluid flowing in the pipe, that is, in the embodiment 5, it is configured to be able to monitor the amount of bubbles produced after the reaction between the sludge and the ozone. The bubble indicator is much smaller in size than the ozone treatment section 3 described in the embodiments 1 to 4, thus contributing to downsizing of the system. The visually observable bubble condition in the bubble indicator is monitored by the bubble detector 5 and transmitted to the control unit 6, to be utilized for controlling the ozone supply unit 2. However, when the influent wastewater increases, a short of ozone feed is likely to occur in the embodiment 5. Accordingly, using a small-capacity ozone generator may possibly bring the sludge volume reduction itself to be unachieved. Hence, if there raises a concern for increase in the influent wastewater, it is preferable to use the ozone concentrating and storing device as described in the embodiment 4.

As described above, the water treatment system according to the present embodiment controls the ozone feed by utilizing the amount of or the increase rate of bubble production accompanied by the reaction between the ozone and the sludge. Put differently, the amount of ozone feed is controlled by utilizing the condition of bubbles as the indicator for the sludge volume reduction. As a result, the amount of ozone feed can be optimized as quickly as possible while keeping stably the sludge volume reduction effect independently of the amount of and the quality of influent wastewater and without using expensive analysis equipment. Optimizing the amount of ozone feed allows the ozone supply unit 2 to feed a proper amount—neither excessive nor deficient—of ozone as quickly as possible, thus contributing to downsizing and cost reduction of the ozone generator. Moreover, the sludge-laden treated water in the aeration tank 1 can be continuously treated using the ejector 8, thus contributing to reduction in size of the system.

### Embodiment 6

A water treatment system according to the embodiment 6 of the present invention is described. The water treatment system according to the embodiment 6 is basically the same in configuration and operation as the embodiments 1 to 4, but is different in that a two-path configuration is provided for recycling to the aeration tank the treated water subjected to ozonation and either one of the two paths is selected depending on an organic substance degradation load of microorganisms in the aeration tank.

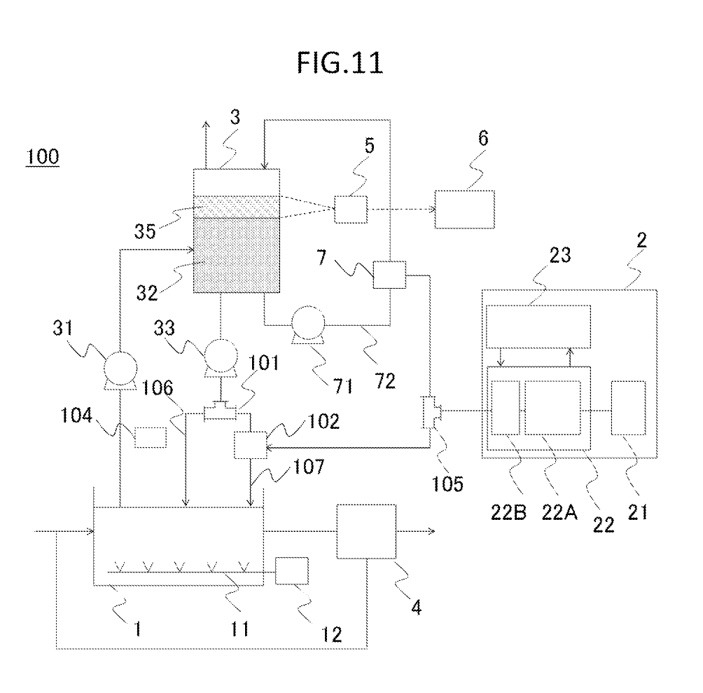

FIG. 11 is a schematic diagram showing a configuration of a water treatment system according to the embodiment 6. In the figure, components as same as or corresponding to those of the water treatment system according to the embodiments 1 to 4 are designated at the same reference numerals, and their descriptions are omitted unless otherwise necessary.

In the embodiments 1 to 4, the ozone treatment is performed on the sludge-laden treated water 32 drawn out from the aeration tank 1 via the pump 31, and the sludge-laden treated water 32 after ozonated is recycled to the aeration tank 1 through one path line by the pump 33. In the embodiment 6, the pump 33 is connected downstream to a pipe 106 and a pipe 107 via a switching valve 101, and another ejector 102 is provided to the pipe 107.

Increase of the organic substance degradation load of microorganisms in the aeration tank 1, which increase is caused by recycle of the ozonated sludge to the aeration tank 1, can be suppressed by the periodic and intermittent ozonation as described before. When the organic substance degradation load of microorganisms in the aeration tank 1 is excessively large, however, the periodic and intermittent ozonation alone is insufficient for the suppression of increase of the organic substance degradation load. This may possibly lead to an occasion of insufficient sludge volume reduction effect or deterioration in quality of the treated water. For such an occasion, the water treatment system of the embodiment 6 is provided with a switching valve controller 104 and the ejector 102 (an example of the ejector section according to the present invention).

The switching valve controller 104 is a component that determines from the detection result of the bubble detector 5 whether or not the organic substance degradation load of microorganisms in the aeration tank is excessively large, and the ejector 102 is a component that performs an additional ozonation. Namely, the water treatment system according to the embodiment 6 performs the ozonation in the ejector 102 on the basis of the determination result of the switching valve controller 104. In this way, reacting in the ejector 102 the ozone gas fed from the ozone supply unit 2 with soluble organic substances eluted from the inside of cell walls can avoid a trouble due to intense bubble production caused by the reaction in the closed space. While FIG. 11 shows an example of using one ejector 102 as an additional ozone reactor, a plurality of ozone reactors may be providing to the pipe 107, for multi-injection of ozone.

When the switching valve controller 104 determines from a detection result of the bubble detector 5 that the organic substance degradation load of microorganisms in the aeration tank is excessively large, the switching valve controller 304 connects the pump 33 to the pipe 107 using the switching valve 101 to supply to the ejector 102 the sludge-laden treated water 32 ozonated in the ozone treatment section 3. Then, the sludge-laden treated water 32 subjected to additional ozonation in the ejector 102 is returned to the aeration tank 1 through the pipe 107 (an example of a first return section according to the present invention). In the case of connecting the pump 33 to the pipe 107, the switching valve controller 104 switches a switching valve 105 to inject into the ejector 102 the ozone gas fed from the ozone supply unit 2, whereby the sludge-laden treated water 32 ozonated in the ozone treatment section 3 is further reacted with the ozone gas. When the switching valve controller 104 determines that the organic substance degradation load of microorganisms in the aeration tank is low, on the other hand, the switching valve controller 104 connects the pump 33 to the pipe 106 using the switching valve 101, to return the sludge-laden treated water 32 ozonated in the ozone treatment section 3 directly to the aeration tank 1 through the pipe 106 (an example of a second return section according to the present invention).

The switching valve controller 104 determines that the organic substance degradation load of microorganisms in the aeration tank is excessively large when, for example, the timing of sharp rise in the increase rate of the bubbles appears earlier than a predetermined time. The determination can be made by comparison with accumulated data obtained by the above-described calibration for inputting the typical value indicating the wastewater conditions to the control unit. Otherwise, the organic substance degradation load of microorganisms in the aeration tank may be determined to be excessively large if the increase rate of bubbles rises sharply while the amount of ozone feed per unit amount of the sludge in the sludge-laden treated water drawn out from the aeration tank 1 is less than 15 mg-O₃/g-SS.

When the organic substance degradation load of microorganisms in the aeration tank is determined to be large as described above, the switching valve controller 104 switches the switching valve 105 at the timing when the increase rate of bubbles rises sharply, with the power supply to the ozone generation part 22 being kept by the control unit 6.

By performing the water treatment as described above, when the organic substance degradation load in the aeration tank is determined to be low on the basis of the bubble detection result, the organic substance degradation load in the aeration tank 1 can be maintained at a proper value even in a case of supplying directly to the aeration tank 1 the high-COD soluble organic substances eluted from the inside of cell walls of microorganisms by the reaction between the sludge and the ozone in ozone treatment section 3; and when the organic substance degradation load in the aeration tank is determined to be high on the basis of the bubble detection result, the organic substance degradation load in the aeration tank 1 can be prevented from increasing owing to reduction of the COD amount supplied to the aeration tank 1 because the amount of soluble organic substances can be reduced by further reacting in the ejector 102 with the ozone the high-COD soluble organic substances eluted from the inside of cell walls of microorganisms by the reaction between the sludge and the ozone in ozone treatment section 3.

The ozone generation part 22 of the present embodiment may be configured to be provided with the ozone generator 22A and the ozone concentrating and storing device 22B as shown in FIG. 11 or to be provided with no ozone concentrating and storing device 22B. However, since the ozone gas feed rate per unit amount of the sludge is physically limited when the ozone gas is injected into the closed pipe, it is preferable to use a super concentrated ozone gas supplied from the ozone concentrating and storing device 22B. Reacting the super concentrated ozone gas, even if its supply rate is low, with the sludge in the ejector 102 allows the high-COD soluble organic substances dissolved from the inside of cell walls to be oxidatively degraded sufficiently, thus preventing the organic substance degradations load in the aeration lank 1 from increasing.

The gas-liquid flow ratio (the ratio of the ozone gas flow rate to the return flow rate of the treated water; referred to as “G/L ratio”, hereinafter) in the ejector 102 is not particularly limited as long as the high-COD soluble organic substances elated from the inside of cell walls in ozone treatment section 3 can be degraded sufficiently. However, the G/L ratio ranges preferably between no lower than 0.02 and no higher than 0.5, more preferably between between no lower than 0.08 and no higher than 0.12 in order to efficiently react the ozone gas with the soluble organic substances. f the G/L ratio is lower than the above range, the amount of ozone gas is deficient. This may possibly lead to insufficient degradation of the soluble organic substances. If the G/L ratio is higher than the above range, on the other hand, the injected ozone gas does not efficiently react with the soluble organic substances and unreached ozone gas is conveyed into the aeration tank 1. Death of microorganisms caused thereby may possibly lead to deterioration in quality of the treated water.

The ozone concentration of the ozone gas is not particularly limited as long as the high-COD soluble organic substances can be sufficiently degraded. However, the concentration ranges preferably between no lower than 600 mg/L and no higher than 2,000 mg/L, more preferably between no lower than 800 mg/L and no higher than 1,500 mg/L. The ozone concentration of the ozone gas within the above range allows the high-COD soluble organic substances to be degraded efficiently under the condition of the G/L ratio ranging between no less than 0.08 and no more than 0.12.

### Embodiment 7

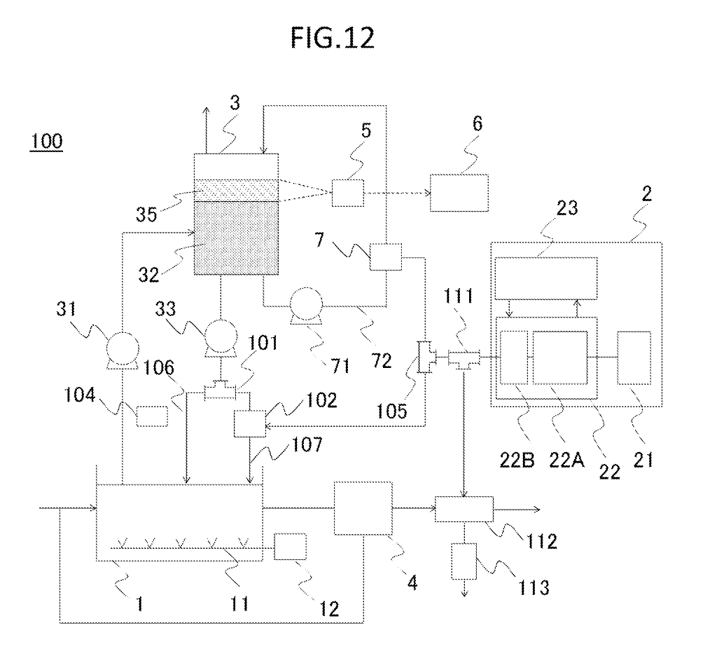

A water treatment system according to the embodiment 7 of the present invention is described. The water treatment system according to the embodiment 7 is basically the same in configuration and operation as the embodiments 1 to 4 and 6, but is different in that an ozone reaction tank is provided downstream to the post treatment section configured with the settling tank, the membrane separation tank, and the like. FIG. 12 is a schematic diagram showing a configuration of a water treatment system according to the embodiment 7. In the figure, components as same as or corresponding to those of the water treatment system according to the embodiments 1 to 4 and 6 are designated at the same reference numerals, and their descriptions are omitted unless otherwise necessary.

In the embodiments 1 to 4 and 6, the post treatment section 4 separates the sludge-laden treated water flowing out from the aeration tank 1 into the excess sludge and the treated effluent, to discharge the separated treated effluent. However, in FIG. 12, since an ozonation tank 112 is provided downstream to the post treatment section 4, the separated treated effluent can be ozonated.

The water treatment system according to the present embodiment is configured to supply the treated effluent separated in the post treatment section 4 to the ozonation tank 112 and to inject the ozone gas fed from the ozone supply unit 2 to the ozonation tank 112 by switching a switching valve 111 in a time period during no periodic and intermittent injection of the ozone gas into the sludge-laden treated water 32. With this configuration, the treated effluent separated in the post treatment section 4 is ozonated in the ozonation tank 112.

The water treatment described above allows for decreasing chromaticity and turbidity of the treated effluent separated in the post treatment section 4 and for removing, by oxidative degradation, organic substances, inorganic substances (such as, for example, ferrous and manganese substances), virus, and the like contained in the treated effluent separated in the post treatment section 4. Consequently, the treated effluent separated in the post treatment section 4 can be enhanced in quality. Unreacted ozone gas not used in the ozonation is sent to a waste ozone decomposer 113 and decomposed into oxygen in the waste ozone decomposer 113 to be discharged into the atmosphere.

### Embodiment 8

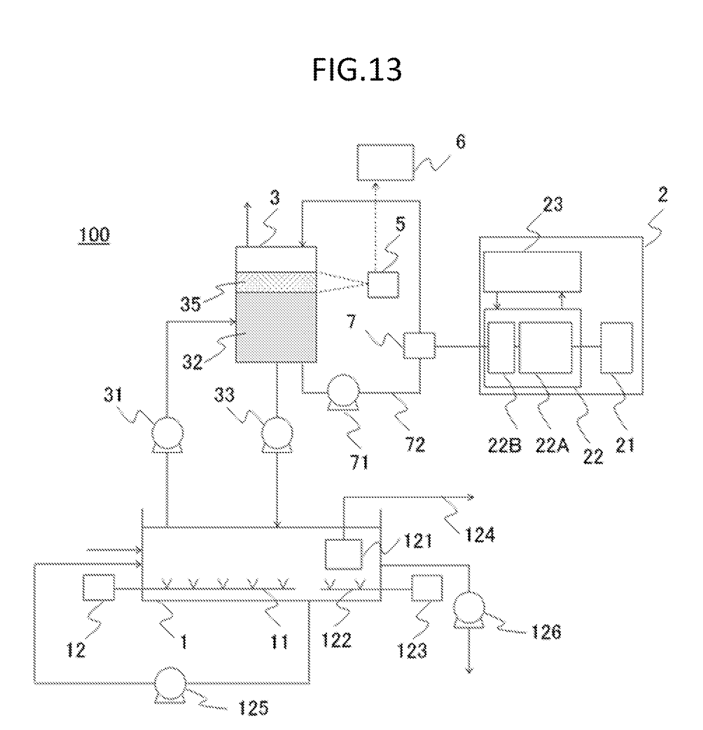

A water treatment system according to the embodiment 8 of the present invention is described. The water treatment system according to the embodiment 8 is basically the same in configuration and operation as the embodiments 1 to 4, but is different in that a membrane module is provided in the aeration tank. FIG. 13 is a schematic diagram showing a configuration of a water treatment system according to the embodiment 8. In the figure, components as same as or corresponding to the system components of the water treatment system according to the embodiments 1 to 4 are designated at the same reference numerals, and their descriptions are omitted unless otherwise necessary.

In the embodiments 1 to 4, the post treatment section 4 is provided downstream to the aeration tank 1. In FIG. 13, the aeration tank 1 is provided with a membrane module 121 therein, another air diffuser 122 placed under the membrane module 121, and an air supply source 123 for introducing air for washing the membrane surface.

In the water treatment system according to the embodiment 8, the aeration tank 1 is filled with the activated sludge with an MLSS concentration of 3,000 to 20,000 mg/L. In a case of raw wastewater such as sewage or industrial effluent flowing into the aeration tank 1, the water is biologically treated by the activated sludge in the aeration tank 1. After that, the biologically treated water is separated into the treated effluent 124 and the activated sludge by filtration of the membrane module 121. In other words, the membrane module 121 functions as an example of filtration treatment means according to the present invention. Since the system is configured such that the activated sludge is circulated in the aeration tank 1 by driving a pump 25, the raw wastewater and the activated sludge can be brought in effective contact with each other. The activated sludge increased by the biological treatment is drawn out from the aeration tank 1 by driving a pump 126, so that the MLSS concentration in the aeration tank 1 is maintained constant. Moreover, the air diffuser 122 connected with the air supply source 123 feeds air to the membrane module 121 to cause membrane fluidization of the activated sludge, so that the filtration is stably performed by the membrane module 121.

The filtration by the membrane module 121 may be continuously performed. However, the filtration is preferably stopped for a certain time at the timing when the pump 33 recycles the ozonated sludge-laden treated water 32 to the aeration tank 1. In this way, the filtration can be stopped by the intermittent filtration treatment when the organic substance degradation load of microorganisms in the aeration tank 1 is increased by recycling the ozonated sludge to the aeration tank 1, thus preventing the treated effluent 124 from deteriorating in quality.

The time duration of no filtration in the intermittent filtration treatment is not particularly limited but may be appropriately set for the treated effluent 124 not to degrade in quality. Specifically, the duration time ranges preferably between no shorter than 30 minutes and no longer than 2 hours, more preferable between no shorter than 30 minutes and no longer than 1 hour. If the time duration of no filtration is shorter than the above range, no effect of preventing the quality deterioration of the treated effluent may possible achieved by the intermittent filtration treatment. If the time duration of no filtration is longer than the above range, on the other hand, per-day filtration treatment duration becomes shorter, and this may possibly lead to an insufficient amount of the treated effluent.

While FIG. 13 shows an example of the one-path configuration for recycling the ozonated sludge-laden treated water 32 to the aeration tank 1 via the pump 33, the two-paths, one of which is for additional ozonation in combination with the ejector, may be provided, for recycling the ozonated sludge-laden treated water 32 to the aeration tank 1 and either one of the two paths is selected depending on the organic substance degradation load of microorganisms in the aeration tank 1 as described in the embodiment 6.

While the embodiment 8 shows an example in which the membrane module 121 is immersed in the one aeration tank 1, the aeration tank 1 may be divided into two or more and the membrane module 121 is immersed in the downstream aeration tank 1. Other than the above, the membrane module 121 housed in a case may be provided outside the aeration tank 1 to perform the filtration treatment while circulating the activated sludge between the housed membrane module 121 and the aeration tank 1. For any of the membrane module arrangements, configurations known in the art may be employed unless the effect of the present invention is inhibited. The type of the filtration membrane constituting the membrane module is not particularly limited, but various types such as a microfiltration (MF) membrane or an ultrafiltration (UF) membrane known in the art may be used.

The average pore size of the filtration membrane of the membrane module 121 is preferable to, but not particularly limited to, 0.001 μm to 1 μm, more preferable to 0.01 μm to 0.8 μm. The type of the filtration membrane is not particularly limited, but a type such as hollow fiber or flat membrane known in the art may be employed. In addition, various types such as am immerse type, a case type, or a monolith type may be employed for the membrane module 121. Further, any of a dead-end type filtration and a cross-flow type filtration may be used for the membrane module 121.

### Embodiment 9

A water treatment system according to the embodiment 9 of the present invention is described. The water treatment system according to the embodiment 9 is basically the same in configuration and operation as the embodiments 1 to 4 and 8, but is different in that ozone-containing water is produced by ozonating a part of the treated effluent filtrated by the membrane module to be used as washing water for the membrane module.

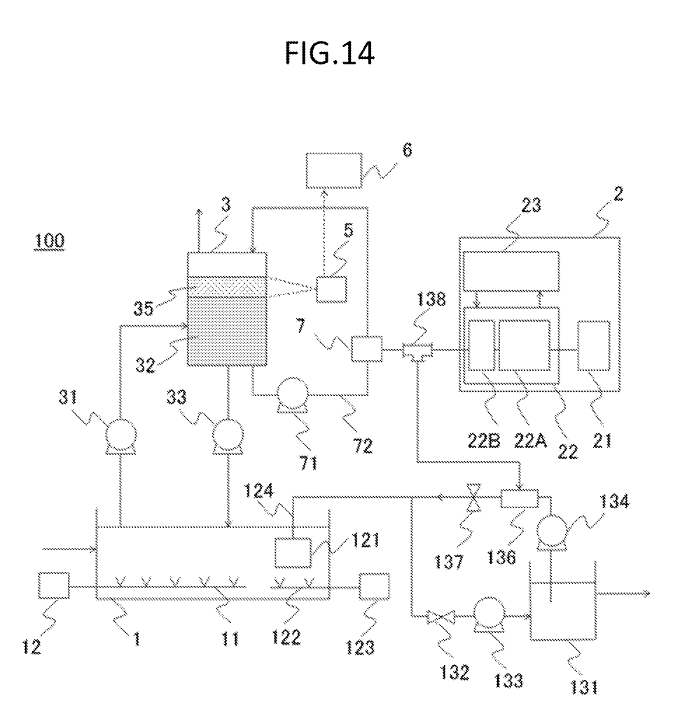

FIG. 14 is a schematic diagram showing a configuration of a water treatment system according to the embodiment 9. In the figure, components as same as or corresponding to those of the water treatment system according to the embodiments 1 to 4 and 8 are designated at the same reference numerals, and their descriptions are omitted unless otherwise necessary. Note that for the sake of avoiding confusion, the pumps 125, 126 and the pipes connected therewith are omitted in FIG. 14.

As shown in FIG. 14, the system is further provided with a treated effluent retaining tank 131 (an example of retaining means according to the present invention) for retaining the treated effluent 124 filtrated by the membrane module 121; a pump 134 for returning to the membrane module 121 a part of the treated effluent 124 retained in the treated effluent retaining tank 131; and an ejector 136 for reacting with the ozone gas the treated effluent 124 to be returned to the membrane module 121.

The water treatment system according to the present embodiment, when performing the filtration using the membrane module 121, opens a solenoid valve 132 and closes a solenoid valve 137 to retain the treated effluent 124 in the treated effluent retaining tank 131 by a pump 133. And part of the treated effluent 124 retained is discharged.

While the ozone gas is periodically and intermittently injected into the sludge-laden treated water 32, operations of closing the solenoid valve 132, opening the solenoid valve 137 and starting the pump 134 are executed periodically in a time period during no injection of the ozone gas into the sludge-laden treated water 32, to return a part of the treated effluent 124 to the membrane module 121. At that time, switching the switching valve 138 allows the ozone gas fed from the ozone supply unit 2 to react with the treated effluent 124 in the ejector 136, so that ozone-containing water is generated. And then, the generated ozone-containing water is returned to the membrane module 121. In other words, the part configured with the solenoid valve 132, the switching valve 138, and ejector 136 functions as an example of generation means according to the present invention, for generating ozone-containing water by ozonating a part of the treated effluent retained.

By performing the above-described water treatment, the membrane module 121 can be periodically washed by using the ozone-containing water. In other words, the part, configured with the solenoid valve 132, the switching valve 138, and ejector 136 also functions as an example of washing means according to the present invention, for washing the filtration treatment means using the generated ozone-containing water. While the filtration is performed, the activated sludge, soluble metabolites, and the like that clog the filtration membrane will adhere the surface, the inside, and the pores of the filtration membrane. However, providing the washing means according to the present invention can efficiently remove the adherents through oxidative decomposition of the ozone-containing water, thus maintaining the filtration performance for a long time. Consequently, the filtration by the membrane module 121 can be performed stably.

In the embodiment 9, the ozone generation part 22 may be configured with the ozone generator 22A and the ozone concentrating and storing device 22B as show in FIG. 11 or configured with the ozone generator 22A alone without the ozone concentrating and storing device 22B. However, since the ozone gas supply rate per unit amount of the sludge is physically limited when the ozone gas is injected into the ejector 136, it is preferable to use a super concentrated ozone gas supplied from the ozone concentrating and storing device 22B. Reacting the super concentrated ozone gas, even if its supply rate is low, with the treated effluent 124 in the ejector 136 allows for generating a super concentrated ozone-containing water, thus washing the membrane module 121 efficiently.

The ozone gas concentration to be injected into the ejector 136 is not particularly limited as long as the ozone-containing water can be generated and the filtration performance of the membrane module 121 can be maintained stably. However, the concentration ranges preferable between no lower than 600 mg/L and no higher than 2,000 mg/L, more preferable between no lower than 800 mg/L and no higher than 1,500 mg/L. The super concentrated ozone-containing water with the concentration within the above range, even if its feed rate is low, can effectively wash the membrane module 121.

The gas-liquid ratio (the above-defined G/L ratio) in the ejector 136 ranges preferably between no lower than 0.02 and no higher than 0.5, more preferably between no lower than 0.08 and no higher than 0.12, from the viewpoint of efficiency of dissolution of injected ozone gas into the treated effluent. If the G/L ratio is lower than the above range, the amount of ozone gas is deficient. This may probably leads to no generation of the ozone-containing water with a sufficient concentration. If the G/L ratio is higher than the above range, on the cither hand, the injected ozone gas does not efficiently react with the treated effluent and unreacted ozone gas is conveyed into the aeration tank 1. Death of microorganisms caused thereby may possibly lead to deterioration in quality of the treated water.

The material of filtration membrane usable for the embodiment 9 is not particularly limited as long as it does not deteriorate with ozone. The material of the filtration membrane includes polyolefin such as polyethylene, polypropylene, and polybutene; or fluororesin compound such as tetrafluoroethylene-perfluoroalkylvinylether copolymer (PFA), tetrafluoroethylene-hexafluoropropylene copolymer (FEP), tetrafluoroethylene-ethylene copolymer (ETFE), polychlorotrifluoroethylene (PCTEF), chlorotrifluoroethylene-ethylene copolymer (ECTFE), polyvinylidene fluoride (PVDF), and polytetrafluoroethylene (PTFE); and further includes celluloses such as cellulose acetate or ethyl celluslose; or ceramics. Among them, fluorine-containing resin compounds or ceramics, which exhibit more excellent ozone resistance, are preferable as a material of the filtration membrane. In addition, the filtration membrane may be formed of any one of the above materials or a combination of two or more thereof.

Note that in FIG. 14, one path is used for returning the ozonated sludge-laden treated water 32 to the aeration tank 1 via the pump 33. However, the system may be configured such that the two paths, one of which is for additional ozonation in combination with the ejector, are provided for recycling the ozonated sludge-laden treated water 32 to the aeration tank 1 and either one is selected depending on the organic substance degradation load of microorganisms in the aeration tank 1 as described in the embodiment 6.

The present invention is not limited to the specific details and the representative embodiments stated and described above. The present invention includes further modification and effect that those skilled in the art can easily derive. Therefore, the present invention may be variously modified without departing from the sprit and the scope defined generically by the accompanying claims and equivalents thereof.

### NUMERAL REFERENCE

2: ozone supply unit; 5: bubble detector; 6: control unit; and 100: water treatment system.

1. A water treatment system that feeds ozone into treated water to be ozonated to reduce volume of an impurity in the treated water, the water treatment system comprising:
an ozone supply device configured to feed a predetermined amount of the ozone into the treated water;
a bubble detector configured to detect bubbles produced by reaction between the ozone and the impurity;
a decisioner configured to determine whether an increasing rate of the detected bubbles is relatively low or relatively high; and
a controller configured to control the ozone supply device to feed the ozone when the decisioner determines that the increasing rate of the bubbles is relatively low and not to feed the ozone when the decisioner determines that the increasing rate of the bubbles is relatively high.

2. The water treatment system of claim 1, wherein the decisioner executes repetitive processing of repeating the determination whether the increasing rate of the bubbles is relatively low or relatively low, and stops the repetitive processing when determines that the increase rate of the bubbles is relatively high and then resumes the repetitive processing after a predetermined time elapses.

3. The water treatment system of claim 1, wherein the treated water is wastewater containing organic substances and the impurity is sludge.

4. The water treatment system of claim 3, wherein the ozone supply device is provided with an electric discharge type ozone generator configured to generate the ozone to be supplied by the ozone supply device.

5. The water treatment system of claim 4, wherein a concentration of the ozone supplied by the ozone supply device ranges from 150 to 310 g/Nm³.

6. The water treatment system of claim 4, wherein the ozone supply device is further provided with an ozone concentrating device configured to concentrate the ozone generated by the electric discharge type ozone generator.

7. The water treatment system of claim 4, wherein a concentration of the ozone fed from the ozone supply device ranges from 800 g/Nm³ to 1,500 g/Nm³.

8. The water treatment system of claim 1, further comprising:
a receiver configured to receive the treated water to be ozonated from an aeration tank containing microorganisms;
an ejector section configured to react by further feeding ozone the treated water into which the ozone is fed;
a first return section configured to return to the aeration tank the treated water reacted in the ejector section;
a second return section configured to return to the aeration tank the treated water into which the ozone is fed, and
a switching valve controller configured to determine, on the basis of a detection result of the bubble detector, whether an organic substance degradation load of microorganisms in the aeration tank is larger or smaller than a predetermined value,
wherein the controller controls so that the treated water into which the ozone is fed flows to the ejector section when the controller determines the organic substance degradation load to be larger than the predetermined value and so that the treated water into which the ozone is fed flows to the second return section when the controller determines the organic substance degradation load to be smaller than the predetermined value.

9. The water treatment system of claim 1, further comprising:
filtration treatment device configured to execute a filtration treatment for separating sludge from the treated water circulating in the aeration tank,
wherein the filtration treatment device stops executing the filtration treatment for a certain time when the treated water is returned to the aeration tank through the first return section or the second return section, and then resumes executing intermittently the filtration treatment after the certain time elapsed.

10. The water treatment system of claim 1, further comprising:
filtration treatment device configured to execute a filtration treatment of separating sludge from the treated water circulating in the aeration tank;
retaining means configured to retain the treated water subjected to the filtration treatment by the filtration treatment device;
generation means configured to generate ozone-containing water by subjecting to ozonation a part of the treated water retained in the retainer; and
washing means configured to wash the filtration treatment means with the ozone-containing water generated by the generator.

11. A water treatment system that feeds ozone into treated water to be ozonated to reduce volume of an impurity in the treated water, the water treatment system comprising:
an ozone supply device configured to feed a predetermined amount of the ozone into the treated water;
an ejector section configured to react the treated water into which the ozone is fed, by feeding ozone of the ozone supply device;
a bubble indicator configured to monitor condition of bubbles produced by reaction between the ozone and the impurity;
a bubble detector configured to detect bubble condition visually observed by the bubble indicator;
a decisioner configured to determine whether an increasing rate of the detected bubbles is relatively low or relatively high; and
a control unit configured to control the ozone supply device to feed the ozone when the decisioner determines that the increasing rate of the bubbles is relatively low and not to feed the ozone when the decisioner determines that the increasing rate of the bubbles is relatively high.

12. A water treatment method using a water treatment system that feeds ozone into treated water to be ozonated to reduce volume of an impurity in the treated water, the water treatment method comprising:
a supply step of feeding a predetermined amount of the ozone into the treated water in the water treatment system;
a detection step of detecting bubbles produced by reaction between the ozone and the impurity; and
a determination step of determining whether an increasing rate of the detected bubbles is relatively low or relatively high,
wherein the ozone is fed in the feed step when the increasing rate of the bubbles is determined to be relatively low in the determination step, and the ozone is not fed in the feed step when the increasing rate of the bubbles is determined to be relatively high in the determination step.
